(19) United States
(12) Patent Application Publication
(10) Pub. No.: US 2006/0165374 A1
(43) Pub. Date: Jul. 27, 2006

(54) Method and apparatus for recording a signal

(76) Inventors: Philip Steven Newton, Eindhoven (NL); Declan Patrick Kelly, Shanghai (CN); Jingwei Tan, Shanghai (CN); Liang Gan, Shanghai (CN); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/564,296

(22) PCT Filed: Jul. 1, 2004
(86) PCT No.: PCT/IB04/51155

§ 371 Date: Jan. 10, 2006

(30) Foreign Application Priority Data
Jul. 14, 2003 (EP) 03102142.1

(51) Int. Cl. H04N 5/91

(52) U.S. Cl. 386/83

(57) ABSTRACT

The invention relates to a system for recording a signal. A recorder (200) comprises a receiver (201) for receiving a source signal (101) having associated first play time information such as a Normal Play Time timeline. The receiver (200) is coupled to a recording controller (203) which generates a recorded signal (301) from the source signal (101). The recorded signal (301) comprises a recording discontinuity with respect to the source signal (101) caused by for example the recording being paused in a time interval. The recording controller (203) is coupled to a storage medium (205). The recorder (200) further comprises a time processor (209) for generating second time information for the recorded signal (301) in response to the first play time information and the recording discontinuity. The second time information may for example be a compensated NPT timeline or event descriptors or stream events having time indications modified to correspond to the recorded signal (301).

The invention relates to a method and apparatus for recording a signal and in particular to a system for recording a signal comprising a recording discontinuity.

The last decade has seen a significant increase in the use of digital techniques for broadcasting of content signal such as radio or television signals. For example, in the last decade a standard has been developed for broadcasting of digital radio known as Digital Audio Broadcasting (DAB). Similarly, a new standard for broadcasting of television has been developed known as the Digital Video Broadcasting (DVB) standard.

The use of digital broadcasting techniques have allowed new functionality including for example interactive TV comprising applications associated with the transmitted signal.

An example of a standard aimed at providing additional functionality and allowing for associated applications is known as the Multimedia Home Platform (MHP) standard. MHP defines a generic interface between interactive digital applications and the terminals on which those applications execute. This interface decouples different provider's applications from the specific hardware and software details of different MHP terminal implementations. It enables digital content providers to address all types of terminals ranging from low-end to high-end set top boxes, integrated digital TV sets and multimedia PCs. The MHP extends the existing, successful DVB open standards for broadcast and interactive services in all transmission networks including satellite, cable, terrestrial and microwave systems.

However MHP has been developed for broadcasting purposes and this has resulted in a number of disadvantages associated with recording of programmes or signals having associated MHP applications. Accordingly, work is currently ongoing in standardising extensions to MHP which aim at increasing performance and functionality when recording MHP video and associated applications.

As the MHP standard was designed for broadcast many of the issues related to storage were not taken into account. One such issue relates to timing information in relation to events in e.g. a video stream. An event may for example be a new scene in a film.

Timing information used in MHP consists in the play back time which in MHP is referred to as Normal Play Time (NPT). NPT is a continuous time line which is associated with the signal throughout the duration of video sequence (e.g. a television programme). The NPT is thus a real time indication running for the entire duration of the video sequence. As the NPT refers to the progress in actual time of the playback of the program, a playback at e.g. twice the normal speed (during fast forward) results in the NPT progressing at twice the normal rate.

During a normal broadcast, the playback rate does not change and it is furthermore not possible to jump to a different location in the video section. However when a signal is recorded, it becomes possible to access the video sequence in a random manner. For example, it may be desirable to jump to a particular time in the program or to skip forward during commercials or to watch replays in a sports event.

However, MHP only provides the possibility to jump in relation to the playback time by performing relative jumps in the NPT time. Thus, a program may jump forward by e.g. 25 minutes relative to the current play back position but cannot jump to an absolute location such as 1 hour into the programme. This is acceptable in many cases where the NPT may be a continuous time line running throughout a video sequence. However, if a recorded video sequence comprises a gap in the recording, the NPT of the recorded video sequence will deviate from that of the original video sequence.

For example, if a video sequence comprises three sections each of ten minutes duration, the third section will start at an NPT of 20 minutes. However, if only the first and third sections are recorded, the recorded third section will start at a recorded NPT of 10 minutes rather than 20 minutes. Thus, if an MHP application comprises a jump to the third section midway through the first section, the relative jump will be set to 15 minutes. However, this relative jump will cause the application to jump to the end of the recorded third section rather than to the beginning. Thus, MHP is not suited for discontinuities in recordings. Such, discontinuities may for example result from pauses in a recording or from an editing of a video sequence.

MHP is furthermore based on the Java platform. Java is a programming language which is interpreted during runtime and provides a complete set of platform independent libraries for developing fully-fledged multimedia applications.

Audio and video playback control in Java is based on the Java Media Framework. This is a library of functions that allows for platform independent control of playback- and capture of audio and video. When storage is added to MHP, the control of playback will be performed through the Java Media Framework. The implementation of the Java Media Framework for MHP will use the NPT of MHP as the linear time base for playback of the audio and video.

The Java Media Framework has several functions that allow an application to jump to a location in an audio or video sequence. These functions are all based on the position in the playback time (the NPT time) of the content. Hence these functions may suffer the same problems as highlighted above when a recording comprises a discontinuity creating a difference between the NPT of the original signal and of the recorded signal.

As a further example, MHP also comprises functionality for an MHP application responding to particular events in the content. For example, an MHP application can be designed to respond to a news item change in a current affairs programme or a goal in a sports match. The mechanism used to trigger an application when such an event occurs is based on using stream events which are descriptors carrying information related to the event and to the timing of the event in the video. The time indication is based on NPT. As an example, a stream event may indicate a goal occurring 25 minutes into a match by comprising a value of the NPT corresponding to 25 minutes into the video sequence (assuming this starts at the start of the match). Thus, applications using stream events are also sensitive to recording discontinuities resulting in different NPTs of the original and the recorded video sequences.

Hence, an improved system for recording would be advantageous.

Accordingly, the Invention preferably seeks to mitigate, alleviate or eliminate one or more of the above mentioned disadvantages singly or in any combination.

According to a first aspect there is provided an apparatus for recording comprising: means for receiving a source signal having associated first play time information; means for generating a recorded signal from the source signal; the recorded signal comprising a recording discontinuity with respect to the source signal; and means for generating second time information for the recorded signal in response to the first play time information and the recording discontinuity.

The invention may specifically allow for second time information which is appropriate for applications and functions dependent on timing information for the recorded signal. The second time information may allow for suitable time information to be generated from the first play time information by compensation for a timing gap associated with the recording discontinuity. The invention may thus allow for and/or facilitate applications and actions requiring timing information despite timing information being affected by a recording discontinuity. Specifically, the invention may allow for timing indications or events related to the first play time information to be appropriately referenced to timing information for the recorded signal. Thus the invention may allow for recording discontinuities to be introduced to a recording process without disrupting or unacceptably affecting algorithms and functions dependent on timing information.

The recorded signal and/or the source signal may preferably comprise a video, audio and/or multimedia data stream. The recorded signal and/or the source signal may further comprise additional data including application data or description data associated with a content signal of the signals.

The invention may for example be applied to a recording of a broadcast source signal or to an editing process of an already stored signal. In an editing process, the stored source signal may be edited and the resulting signal may be stored (or recorded) in addition to or instead of the originally stored source signal. The second time information may be stored separately or together with a content stream of the signal. For example, the second time information may be stored in a separate file or may be embedded in e.g. a video data stream.

According to a feature of the invention, the second time information comprises markers indicating events in the recorded signal. Markers may for example be indications associating an occasion in a content signal of the source signal to a time indication for the recorded signal. For example, a new scene of a video sequence may be associated with a specific NPT for the recorded signal. The markers are preferably stored in a separate file which may be stored with the recorded signal. This allows for a very flexible and simple method for relating timings and events which is suitable for use by applications and functions performed on the recorded signal during play back. The markers may be determined by e.g. content analysis of the content signal or by detection of a change in characteristics of the content signal (e.g. scene change).

According to another feature of the invention, the second time information comprises a play list comprising the markers. A play list allows for a particularly suitable implementation where timing information for the recorded signal may easily and flexibly be used by applications and functions.

According to another feature of the invention, the second time information comprises event descriptors. An event descriptor may for example comprise or consist in a stream event. An event descriptor may comprise an association between an event related to the source signal and a time indication. For example, an event descriptor indicating that an application should be executed at a given time instant may comprise an identification of the application and an indication of the NPT of the recorded signal at which this is to be executed. This allows for a simple and flexible implementation allowing applications and functions to perform timed operations on a recorded signal despite this comprising a recording discontinuity with respect to the source signal.

According to another feature of the invention, the means for generating the second time information is operable to generate time information of the event descriptors by modifying time information of event descriptors associated with the source signal.

Frequently source signals comprising a content signal also comprises event descriptors such as embedded indications of applications and an associated execution time. These stream events may advantageously be included in the second timing information by generating corresponding event descriptors wherein the execution time is modified to the corresponding timing of the recorded signal. This allows for the functionality associated with event descriptors in the source signal to be maintained for the recorded signal despite the recording comprising a recording discontinuity.

According to another feature of the invention, the means for generating the second time information is operable to generate the time information of the event descriptors by compensating the time information of event descriptors associated with the source signal by a time gap associated with the recording discontinuity.

For example, any timing indications related to events following a recording discontinuity may simply be reduced by a value equal to the time gap of the recording discontinuity. This allows for a particularly low complexity and facilitates implementation.

According to another feature of the invention, time information of the event descriptors comprise relative time information associated with a play time line. Hence, the invention may allow for event descriptors comprising relative time indications to be transferred to a recorded signal having a recording discontinuity.

According to another feature of the invention, the apparatus for recording further comprises means for extracting the event descriptors associated with the source signal from a transport signal comprising the source signal. This allows for an implementation wherein event descriptors of the source signal may be retained for the recorded signal.

According to another feature of the invention, the event descriptor comprises a stream event comprising information for triggering an application. This allows for a recorded signal having a recording discontinuity to maintain triggering of applications at the appropriate time instants.

According to another feature of the invention, the first play time information comprises a first play time line and the means for generating the second time information is operable to generate a non-continuous play time line associated with the recorded signal and having a time discontinuity corresponding to the recording discontinuity.

Specifically, the first play time line and the non-continuous play time line may be real time play time lines such as NPT time lines. A non-continuous play time line may allow for all the relative and absolute time indications associated with the first play time line to be directly suitable for the non-continuous play time for the recorded signal. Hence, existing time references may be used for a recorded signal having a recording discontinuity. The non-continuous play time may simply comprise a gap corresponding to a time gap associated with the recording discontinuity.

Preferably, the source signal and the recorded signal comprise Multimedia Home Platform (MHP) data and/or Digital Video Broadcast (DVB) data.

According to a second aspect of the feature of the invention, there is provided a method of recording comprising the steps of: receiving a source signal having associated first play time information; generating a recorded signal from the source signal; the recorded signal comprising a recording discontinuity with respect to the source signal; and generating second time information for the recorded signal in response to the first play time information and the recording discontinuity.

These and other aspects, features and advantages of the invention will be apparent from and elucidated with reference to the embodiment(s) described hereinafter.

An embodiment of the invention will be described, by way of example only, with reference to the drawings, in which

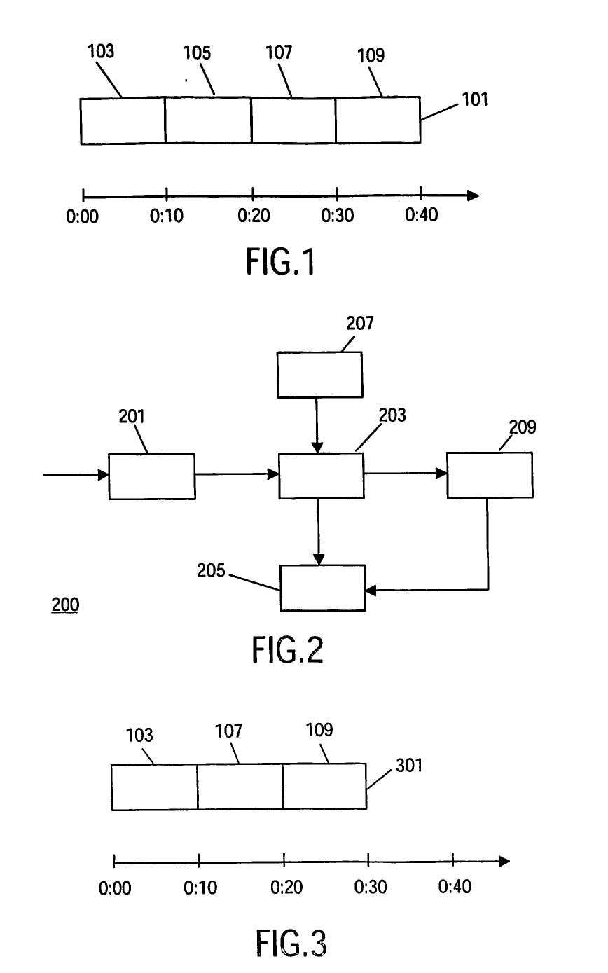

FIG. 1 illustrates a DVB source signal 101 comprising a TV programme;

FIG. 2 shows a block schematic of an apparatus for recording in accordance with an embodiment of the invention; and

FIG. 3 shows an example of a recorded signal in accordance with an embodiment of the invention.

The following description focuses on an embodiment of the invention applicable to a recorder for recording a source signal comprising Multimedia Home Platform (MHP) data and Digital Video Broadcast (DVB) video data. However, it will be appreciated that the invention is not limited to this application but may be applied to many other signals and standards as for example the DASE standard in the US.

The preferred embodiment will in the following be described with reference to an exemplary source signal comprising a video sequence in the form of a television programme being broadcast in accordance with the DVB standard. FIG. 1 illustrates a DVB source signal 101 comprising a TV programme. In the shown example, the source signal 101 comprises four consecutive sections 103, 105, 107, 109. For example, the TV programme may be a sports programme showing highlights of four football matches with each section comprising one match.

The source signal has associated play time information in the form of a Normal Play Time (NPT) 111 which is a continuous timeline running for the duration of the programme. Thus, in the example section 1 103 starts at an NPT of 0:00 (in hours:minutes format), section 2 105 starts at an NPT of 0:10, section 3 107 starts at an NPT of 0:20, section 4 109 starts at an NPT of 0:30 and the programme ends at an NPT of 0:40.

FIG. 2 shows a block schematic of an apparatus for recording in accordance with an embodiment of the invention.

The recorder 200 comprises a receiver 201 for receiving the source signal 101. In the preferred embodiment, the receiver 201 is a DVB radio receiver operable to receive a broadcast in accordance with the DVB standard. Implementation of DVB receivers is well known in the art and will for brevity and clarity not be described in more detail.

In other embodiments, the receiver 201 is operable to receive the source signal 101 from other means and specifically the receiver 201 may be operable to receive a source signal 101 from local or remote storage means. In some embodiments, the receiver 201 may be operable to receive the source signal 101 from the same storage means which is used for storing the recorded signal. The recorder 200 may thus be an editing apparatus.

The receiver 201 is coupled to a recording controller 203 which controls the recorder 200 and in particular controls the recording process.

The recording controller 203 is coupled to a storage medium 205 which is operable to store a signal being recorded. The storage medium 205 may be any suitable means for storing signals including for example solid state memory, optical storage mediums (such as recordable Compact Discs or Digital Versatile Discs) or magnetic storage means. In the preferred embodiment, the storage medium 205 is implemented as a hard disk operable to store digital data.

The recording controller 203 is furthermore coupled to a user input 207 which enables a user of the recorder 200 to control the functionality of the recorder 200.

The recording controller 203 is operable to generate a recorded signal from the source signal 101 in response to user inputs. In a simple embodiment, the user input may simply consist in starting, pausing and stopping a recording. In this case, the recording controller 203 will generate the recorded signal as the source signal when the user has started a recording. If the user pauses the recording, the recording controller 203 will not add more data to the recorded signal. When the pause is terminated, the part of the source signal 101 now being received will be appended to the existing recorded signal. Thus, the recorded signal may comprise a recording discontinuity. In the preferred embodiment, the recorded signal is continually fed to the storage medium 205 under the control of the recording controller 203. Thus, the recorded signal is continually stored during the recording process.

In more complex embodiments, the recording process may be controlled automatically or semi-automatically by the recording controller 203 with none or limited input from the user. For example the user may specify a number of parameters and characteristics for the desired recording process, and the recording controller 203 may control the recording automatically to meet these parameters. In some embodiments, more advanced processing and user control is implemented as part of the recording process. For example, the recording controller 203 may implement full editing functionality allowing for a stored signal to be retrieved modified and re-stored (recorded). Thus the recording process may comprise functionality allowing the recorded signal to be generated by e.g. removal or insertion of sections. This will naturally result in a recording discontinuity causing the NPT to differ between the source signal 101 and the recorded signal.

As a specific example of a recording process resulting in a recording discontinuity, a user may instigate recording of the source signal 101 of FIG. 1. However, the user may not be interested in the highlights of the second match and accordingly may pause the recording during section 2 105 of the source signal. FIG. 3 illustrates a recorded signal 301 that may result from this operation. As illustrated, section 1 103 is directly followed by section 3 107 which is followed by section 4 109. Thus, for the recorded signal, section 1 103 starts at an NPT of 0:00, section 3 107 starts at an NPT of 0:10, section 4 109 starts at an NPT of 0:20 and the programme ends at an NPT of 0:30.

The inventors of the current invention have realised that disadvantages may arise from a recording discontinuity. For example, if during playback the user or an MHP application wishes to jump to another section, the system will use the NPT as a time reference to jump to that section. If, for example, an MHP application comprises functionality to jump to the start of section 3 midway through section 1, this will be implemented as a relative jump by 15 minutes, i.e. from an NPT of 0:05 to 0:30. For the original source signal (or a recorded signal having no recording discontinuities), this will result in a jump to the beginning of section 3. However, when the application is executed for the recorded signal, the resulting NPT does not correspond to the start of section 3 but rather coincides with the start of section 4. Thus, the MHP application will malfunction.

This issue does not only occur for relative time jumps but also occurs for e.g. stream events associated with the source program. These stream events may indicate an NPT at which point an event occurs or an MHP application should be executed. However, as the NPTs of the source signal 101 and the recorded signal 301 differ these time indications are incorrect for the recorded signal 301 and thus all functionality associated with the stream events become corrupted.

In accordance with the preferred embodiment, the recorder 200 further comprises a time processor 209 coupled to the recording controller 203. The time processor 209 is operable to generate second time information for the recorded signal in response to the play time information and the recording discontinuity. Thus, the recorder 200 generates second timing information which enables the timing differences between the source signal 101 and the recorded signal 301 to be compensated for. The second time information allows for applications and functionality associated with the source signal 101 to be used with the recorded signal 301. Thus, functionality available for the source signal 101 will also be available for the recorded signal 301 and indeed additional functionality may be possible due to the accessibility to different elements of a recorded signal.

In the preferred embodiment, the time processor 209 is furthermore coupled to the storage medium 205 and is operable to store the second time information together with the recorded signal 301. The second time information may for example be stored in a separate file or may be embedded with the recorded signal.

In some embodiments of the invention, the second time information comprises markers indicating events in the recorded signal.

In one such embodiment, the recording controller 203 detects characteristics of the source signal and/or the recorded signal and provides these characteristics to the time processor 209 which in response generates markers comprising an association between a characteristic and a time instant of the NPT of the recorded signal.

For example, the recording controller 203 may detect all scene changes in a video sequence and inform the time processor 209 of the corresponding NPT times of the source signal. The time processor 209 is furthermore fed with information related to the timing of any recording discontinuities and accordingly generates a timing of the marker in response to this information. Thus, the time processor 209 may be provided with information that the recording has been paused between an NPT of 0:10 and 0:20. In accordance, if it receives information of a scene change occurring at an NPT of the source signal of 0:25, it will generate a marker indicating that this scene change occurs at an NPT of the recorded signal of 0:15.

In the embodiment, a play list is generated by compiling the generated markers. During play back, navigation and jumps may be performed using the markers of the play list. Hence, if the recording is paused, jumps within the content would still be consistent.

In some embodiments, the recording controller 203 may perform content analysis of the received signal and markers may be generated in response to this content analysis. For example, goals in a football match may be detected by a sudden increase of spectator noise followed by a number of replays. The goal detection may be passed to the time processor 209 which may generate a marker indicating the NPT of the recorded signal at which the goal occurs.

The markers are preferably stored in a separate file associated with the file comprising the recorded signal. However, the markers may also be included in the same file as the recorded signal and may even be embedded in the recorded signal.

In some embodiments, the first play time information comprises a first play time line which specifically may be an NPT timeline as previously described. In some of these embodiments, the time processor 209 is operable to generate a non-continuous play timeline associated with the recorded signal and having a time discontinuity corresponding to the recording discontinuity.

Specifically, the time processor 209 may be operable to generate an NPT for the recorded signal which has a discontinuity corresponding to the time gap of any recording discontinuities. Thus, the generated NPT time line may have the same NPT for the same content as the original source signal but will have a part of the NPT corresponding to the recording gap missing.

In the specific example illustrated in FIG. 3, the time processor 209 may thus generate an NPT running from 0:00:00 (in hours:minutes:seconds format) to 0:09:59. However, the NPT then jumps from 0:09:59 to 0:20:00 and proceeds therefrom. Thus, whenever a recording gap occurs, a corresponding discontinuity is introduced to the NPT of the recorded signal. The non-continuous NPT may be stored separately from or together with the recorded signal.

Any applications and functions associated with the NPT of the original source signal may be used directly with the recorded signal. For example, in the previous example where an application jumps to section 3 107 midway through section 1 103, the calculated NPT of 0:30 will still be appropriate although this will now refer to a location only 20 minutes into the recorded signal.

In the preferred embodiment, the second time information comprises event descriptors. These event descriptors identify an event and have an associated time indication. The event descriptors are generated by the time processor 209 such that the time indication relates to the NPT of the recorded signal.

Frequently, a source signal may comprise a number of event descriptors. For example, a broadcast DVB signal may comprise a number of stream events which comprise information of when an event occurs (e.g. a new section of the programme starts) or when an event should occur (e.g. when an MHP application should be started). The time indication of the stream events of the source signal refers to the NPT of the source signal.

In the preferred embodiment, the recording controller 203 extracts the event descriptors associated with the source signal from a transport signal comprising the source signal. The transport signal may be the same as the source signal or may be a data stream comprising the source signal. The extracted stream events are fed to the time processor 209.

The time processor 209 is operable to generate time information of the event descriptors by modifying time information of event descriptors associated with the source signal. The time processor 209 thus reads the time indication of the extracted event descriptors and changes the time indication such that it corresponds to the NPT of the recorded signal.

Specifically, the time processor 209 generates the time information of the event descriptors by compensating the time information of event descriptors associated with the source signal by a time gap associated with the recording discontinuity.

In a simple embodiment, the time processor 209 simply adds or subtracts the corresponding time interval of any removed or added sections of the recorded signal with respect to the source signal. In the example of FIG. 3, all event descriptors relating to section 1 103 are thus unchanged whereas all event descriptors relating to section 3 or 4 are generated by subtracting 10 minutes from the time indication of the corresponding event descriptor of the source signal 101. In the case of an editing operation adding a new section, the time indications of all event descriptors relating to sections following the added section are simply increased by an amount corresponding to the duration of the added section.

The generated event descriptors of the second time information may e.g. be stored in a separate information file or may be embedded in the recorded signal.

As a specific example, the source signal of FIG. 1 may in section 1 comprise a stream event indicating that a specific MHP application should be triggered at the start of section 4, i.e. at an NTP of 0:30. The stream event may be included at the start of section 1 and comprise a relative time indication thus indicating that the MHP application should be started 30 minutes after the occurrence of the stream event.

The stream event is extracted from the source signal 101 and fed to the time processor 209. The time processor 209 furthermore has been provided with information that a 10 minute recording gap was introduced. The time processor 209 calculates a new time indication by subtracting 10 minutes from the original time indication as this refers to a time after the recording gap. Thus a stream event is generated indicating that the MHP application should be triggered 20 minutes after the occurrence of the stream event, and the stream event is inserted at the beginning of section 1 in the recorded signal 301.

Accordingly, during play back of the recorded signal, the MHP application will correctly be started at the beginning of section 4 without requiring any modifications to the play back functionality or equipment.

Thus, a recorder allowing for recording discontinuities to be introduced to a recording process without disrupting or unacceptably affecting algorithms and functions dependent on timing information is provided.

It will be appreciated that different approaches for the generating second time information may be used in isolation or in any combination or permutation.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. An apparatus (200) for recording comprising:
means (201) for receiving a source signal (101) having associated first play time information;
means (203) for generating a recorded signal (301) from the source signal (101); the recorded signal (301) comprising a recording discontinuity with respect to the source signal (101); and
means (209) for generating second time information for the recorded signal (301) in response to the first play time information and the recording discontinuity.

2. An apparatus (200) for recording as claimed in claim 1 wherein the second time information comprises markers indicating events in the recorded signal (301).

3. An apparatus (200) for recording as claimed in claim 2 wherein the second time information comprises a play list comprising the markers.

4. An apparatus (200) for recording as claimed in claim 1 wherein the second time information comprises event descriptors.

5. An apparatus (200) for recording as claimed in claim 4 wherein the means (209) for generating the second time information is operable to generate time information of the event descriptors by modifying time information of event descriptors associated with the source signal (101).

6. An apparatus (200) for recording as claimed in claim 5 wherein the means (209) for generating the second time information is operable to generate the time information of the event descriptors by compensating the time information of event descriptors associated with the source signal (101) by a time gap associated with the recording discontinuity.

7. An apparatus (200) for recording as claimed in claim 5 wherein time information of the event descriptors comprise relative time information associated with a play time line.

8. An apparatus (200) for recording as claimed in claim 5 further comprising means for extracting the event descriptors associated with the source signal (101) from a transport signal comprising the source signal (101).

9. An apparatus (200) for recording as claimed in claim 4 wherein the event descriptor comprises a stream event comprising information for triggering an application.

10. An apparatus (200) for recording as claimed in claim 1 wherein the first play time information comprises a first play time line and the means (209) for generating the second time information is operable to generate a non-continuous play time line associated with the recorded signal and having a time discontinuity corresponding to the recording discontinuity.

11. An apparatus (200) for recording as claimed in claim 1 wherein the source signal (101) and the recorded signal (301) comprise Multimedia Home Platform (MHP) data.

12. An apparatus (200) for recording as claimed in claim 1 wherein the source signal (101) and the recorded signal (301) comprise Digital Video Broadcast (DVB) data.

13. A method of recording comprising the steps of
receiving a source signal (101) having associated first play time information;
generating a recorded signal (301) from the source signal (101); the recorded signal (301) comprising a recording discontinuity with respect to the source signal (101); and
generating second time information for the recorded signal (301) in response to the first play time information and the recording discontinuity.

14. A computer program enabling the carrying out of a method according to claim 13.

15. A record carrier comprising a computer program as claimed in claim 14.

16. A programmed computer enabled to execute the method according to claim 13.
